(19) United States
(12) Patent Application Publication
(10) Pub. No.: US 2025/0100018 A1
(43) Pub. Date: Mar. 27, 2025

(54) CHEMICAL MECHANICAL POLISHING DEVICE

(71) Applicant: SAMSUNG ELECTRONICS CO, LTD., Suwon-si (KR)

(72) Inventors: Jonggun SONG, Suwon-si (KR); Yunseok CHOI, Suwon-si (KR); Eunseok LEE, Suwon-si (KR); Jaeock CHOI, Suwon-si (KR)

(73) Assignee: SAMSUNG ELECTRONICS CO, LTD., Suwon-si (KR)

(21) Appl. No.: 18/750,326

(22) Filed: Jun. 21, 2024

(30) Foreign Application Priority Data
Sep. 27, 2023 (KR) 10-2023-0131155
Dec. 1, 2023 (KR) 10-2023-0172732

(51) Int. Cl. B08B 1/12; B08B 1/40; B08B 11/00; B24B 53/017

(52) U.S. Cl. CPC B08B 1/12; B08B 1/40; B08B 11/00; B24B 53/017

(57) ABSTRACT

A chemical mechanical polishing device includes a frame providing lower and upper spaces in the frame and including a flat plate portion that separates the lower and upper spaces from each other and has a first hole, a driving roller in the lower space and configured to rotate in place, a cleaning assembly in the upper space and configured to reciprocate in a first horizontal direction parallel to an upper surface of the flat plate portion, and a driver extending from the upper space to the lower space through the first hole of the flat plate portion and having one end connected to a base of the driving roller and the other end opposite to the one end and connected to the cleaning assembly, wherein the cleaning assembly includes brushes arranged apart from each other in the first horizontal direction and nozzles arranged respectively between the brushes.

### CROSS-REFERENCE TO RELATED APPLICATION

This application is based on and claims priority to Korean Patent Application No. 10-2023-0131155, filed on Sep. 27, 2023, and Korean Patent Application No. 10-2023-0172732, filed on Dec. 1, 2023, in the Korean Intellectual Property Office, the disclosures of which are incorporated by reference herein in their entirety.

### BACKGROUND

The present disclosure relates to a chemical mechanical polishing device.

In various processes, such as etching processes, ion implantation processes, and photolithography processes, which are included in semiconductor device manufacturing processes, for example, contaminants including organic materials may be generated. Therefore, a cleaning process for removing contaminants remaining on manufacturing facilities may be performed between unit processes of a semiconductor device manufacturing process. Research has been conducted on cleaning process conditions, which may improve cleaning efficiency and prevent damage to manufacturing facilities for semiconductor devices, in such cleaning processes.

### SUMMARY

The present disclosure provides a chemical mechanical polishing device capable of effectively cleaning contaminants remaining on manufacturing facilities.

According to an aspect of the present disclosure, there is provided a chemical mechanical polishing device including a frame providing a lower space and an upper space in the frame and including a flat plate portion that separates the lower space and the upper space from each other and has a first hole, a driving roller arranged in the lower space and configured to rotate in place, a cleaning assembly arranged in the upper space and configured to reciprocate in a first horizontal direction that is parallel to an upper surface of the flat plate portion, and a driver extending from the upper space to the lower space through the first hole of the flat plate portion and having one end fastened to a base of the driving roller and the other end that is opposite to the one end and connected to the cleaning assembly, wherein the cleaning assembly includes a plurality of brushes, which are arranged apart from each other in the first horizontal direction, and a plurality of nozzles arranged respectively between the plurality of brushes.

According to another aspect of the present disclosure, there is provided a chemical mechanical polishing device including a polishing pad arranged on a polishing platen and configured to be rotatable, a carrier head assembly configured to provide a wafer onto the polishing pad, a temperature adjuster configured to spray, onto the polishing pad, a temperature control fluid for adjusting a temperature of the polishing pad, and a cleaning device configured to clean a lower surface of the carrier head assembly or a lower surface of the temperature adjuster, wherein the cleaning device includes a frame providing a lower space and an upper space in the frame and including a flat plate portion that separates the lower space and the upper space from each other and has a first hole extending lengthwise in a first horizontal direction, a driving roller arranged in the lower space and configured to rotate in place, a cleaning assembly arranged in the upper space and configured to reciprocate in the first horizontal direction, and a driver extending from the upper space to the lower space through the first hole of the flat plate portion and having one end fastened to a base of the driving roller and the other end that is opposite to the one end and connected to the cleaning assembly, and wherein the cleaning assembly includes a plurality of brushes and a plurality of nozzles arranged respectively between the plurality of brushes, the plurality of brushes being arranged apart from each other in the first horizontal direction and each including a plate having an upper surface that is parallel to an upper surface of the flat plate portion.

According to another aspect of the present disclosure, there is provided a chemical mechanical polishing device including a polishing pad arranged on a polishing platen and configured to be rotatable, a carrier head assembly configured to provide a wafer onto the polishing pad, a temperature adjuster configured to spray, onto the polishing pad, a temperature control fluid for adjusting a temperature of the polishing pad, a first cleaning device configured to clean a lower surface of the carrier head assembly, and a second cleaning device configured to clean a lower surface of the temperature adjuster, wherein each of the first cleaning device and the second cleaning device includes a frame providing a lower space and an upper space in the frame and including a flat plate portion that separates the lower space and the upper space from each other and has a first hole extending lengthwise in a first horizontal direction, a driving roller arranged in the lower space and configured to rotate in place, a cleaning assembly arranged in the upper space and configured to reciprocate in the first horizontal direction, and a driver including a first arm, which is connected with the cleaning assembly and extends through the first hole in a vertical direction that is perpendicular to an upper surface of the flat plate portion, a second arm connected with the first arm and extending in the first horizontal direction, a third arm having one end connected with the second arm and the other end that is opposite to the one end and connected with the driving roller, and a pivot securing the third arm to the second arm, and wherein the cleaning assembly includes a plurality of brushes and a plurality of nozzles arranged respectively between the plurality of brushes, the plurality of brushes being arranged apart from each other in the first horizontal direction and each including a plate having an upper surface that is parallel to the upper surface of the flat plate portion.

### BRIEF DESCRIPTION OF DRAWINGS

Embodiments of the present disclosure will be more clearly understood from the following detailed description taken in conjunction with the accompanying drawings in which:

FIGS. 1 and 2 are perspective views of chemical mechanical polishing devices according to the present disclosure;

FIG. 3 is a perspective view of a cleaning device shown in FIG. 2;

FIG. 4 is a cross-sectional view of the cleaning device of FIG. 2, taken along a line X-X′ of FIG. 3;

FIG. 5 is a cross-sectional view of the cleaning device of FIG. 2, taken along a line Y-Y′ of FIG. 3;

FIG. 6 is a plan view of the cleaning device shown in FIG. 2;

FIGS. 7, 8, and 9 are plan views of cleaning devices of chemical mechanical polishing devices according to some embodiments;

FIG. 10 is a cross-sectional view of a cleaning device of a chemical mechanical polishing device according to an embodiment;

FIGS. 11 to 14 are cross-sectional views and plan views illustrating an operation process of a cleaning device of a chemical mechanical polishing device according to an embodiment; and

FIGS. 15 to 18 are cross-sectional views and plan views illustrating another operation process of a cleaning device of a chemical mechanical polishing device according to an embodiment.

### DETAILED DESCRIPTION

Hereinafter, embodiments of the present disclosure will be described in detail with reference to the accompanying drawings. However, the present disclosure is not necessarily configured as defined in the following embodiments and may be embodied in any different ways. The following embodiments are provided for sufficiently conveying the scope of the present disclosure to those of ordinary skill in the art rather than provided for allowing the present disclosure to be fully completed.

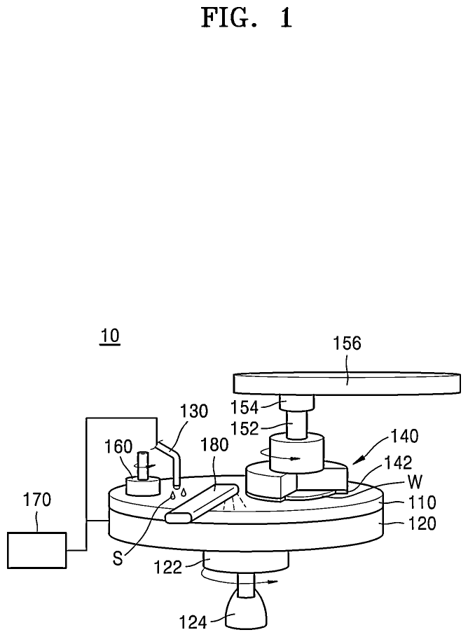

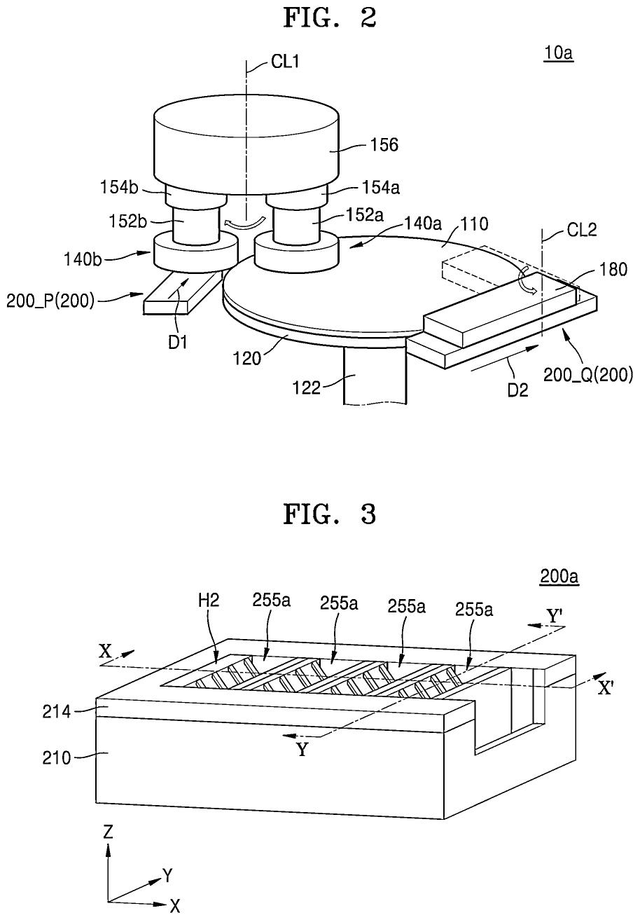

FIGS. 1 and 2 are respectively perspective views of chemical mechanical polishing devices 10 and 10a according to the present disclosure.

Referring to FIG. 1, the chemical mechanical polishing device 10 according to an embodiment may include a polishing pad 110, a platen 120, a slurry supplier 130, a carrier head assembly 140, a pad conditioner 160, a temperature controller 170, and a temperature adjuster 180.

The polishing pad 110 may be arranged on the platen 120. The polishing pad 110 may include a polishing pad for chemical mechanical polishing. For example, the polishing pad 110 may include a polymer matrix and a temperature sensitizer. The polishing pad 110 may be provided as a plate, for example, a circular plate, which has a certain thickness, but the present disclosure is not limited thereto. The polishing pad 110 may include a polishing surface having certain roughness. While a chemical mechanical polishing process is being performed, the polishing surface of the polishing pad 110 may contact a wafer W to polish the wafer W.

The polishing pad 110 may include a porous material having a plurality of microspaces. The microspaces of the polishing pad 110 may accommodate a polishing slurry S provided while the chemical mechanical polishing process is being performed. In some embodiments, the polishing pad 110 may further include a conductive material. The polishing pad 110, which includes a conductor, may be grounded and thus prevent the generation of a short-circuit. In some embodiments, the polishing pad 110 may include a non-conductor.

The platen 120 may be rotatable. The platen 120 may rotate the polishing pad 110 arranged on the platen 120. For example, a platen driving shaft 122 connected to the lower portion of the platen 120 may rotate by receiving rotational power from a platen motor 124. The platen 120 may rotate the polishing pad 110 about a rotation axis that is perpendicular to the upper surface of the platen 120.

The slurry supplier 130 may be arranged adjacent to the polishing pad 110. While a chemical mechanical polishing process is being performed, the slurry supplier 130 may supply the polishing slurry S onto the polishing pad 110. The polishing slurry S may include, but is not limited to, for example, a reaction agent (for example, deionized water for oxidation polishing), polishing particles (for example, silica for oxidation polishing), and/or a chemical reaction catalyst (for example, potassium hydroxide for oxidation polishing).

The carrier head assembly 140 may be arranged adjacent to the polishing pad 110. The carrier head assembly 140 may provide the wafer W onto the polishing pad 110. The carrier head assembly 140 may operate to cause the wafer W to contact the polishing pad 110 and be maintained in contact with the polishing pad 110. The carrier head assembly 140 may independently control polishing parameters (for example, pressure and the like) related to each wafer W.

For example, the carrier head assembly 140 may include a retaining ring 142 to retain the wafer W under a flexible membrane. The carrier head assembly 140 may include a plurality of pressurizable chambers, which are defined by the flexible membrane and may be independently controlled. The pressurizable chambers may apply independently controllable pressure to related regions of the flexible membrane or related regions of the wafer W, respectively.

The carrier head assembly 140 may be rotatable. The carrier head assembly 140 may rotate the wafer W secured to the carrier head assembly 140. For example, a first driving shaft 152 connected to an upper portion of the carrier head assembly 140 may rotate by receiving rotational power from a first motor 154.

The carrier head assembly 140 may be supported by a support structure 156. The support structure 156 may include, but is not limited to, a carousel or a track. In some embodiments, the carrier head assembly 140 may laterally translate across the upper surface of the polishing pad 110. For example, the carrier head assembly 140 may be vibrated on a slider of the support structure 156 or by the rotational vibration of the support structure 156 itself or the like.

The pad conditioner 160 may be arranged adjacent to the polishing pad 110. The pad conditioner 160 may perform a conditioning process on the polishing pad 110. The pad conditioner 160 may maintain the polishing surface of the polishing pad 110 stable such that the wafer W is effectively polished during a chemical mechanical polishing process.

The temperature controller 170 may control a polishing temperature at which a chemical mechanical polishing process is performed on the wafer W. For example, the temperature controller 170 may be connected with the platen 120 and may heat or cool the polishing pad 110 arranged on the platen 120. Alternatively, for example, the temperature controller 170 may be connected with the slurry supplier 130 and may heat or cool the polishing slurry S supplied from the slurry supplier 130. The temperature controller 170 may include, but is not limited to, for example, a temperature controlling device or the like.

The temperature adjuster 180 may be arranged above the polishing pad 110 to be apart from the slurry supplier 130. The temperature adjuster 180 may be arranged in front of the slurry supplier 130. The temperature adjuster 180 may adjust the surface temperature of the polishing pad 110 by spraying a temperature controlling fluid to the upper surface of the polishing pad 110. The temperature adjuster 180 may include at least one nozzle and may increase or decrease the surface temperature of the polishing pad 110 by spraying the temperature controlling fluid to the surface of the polishing pad 110 through the nozzle. The temperature controlling fluid may include a liquid or a gas capable of being sprayed through the nozzle. The temperature controlling fluid may include a liquid, such as heated or cooled deionized (DI) water. The temperature controlling fluid provided by the temperature adjuster 180 may adjust the temperature of the polishing pad 110 in advance before the temperature of the polishing pad 110 is adjusted by a slurry provided by the slurry supplier 130, thereby supplementing a temperature adjusting effect of the slurry and thus adjusting the temperature of the polishing pad 110.

Because each of the slurry supplied by the slurry supplier 130 and the temperature controlling fluid supplied by the temperature adjuster 180 is heated or cooled and then supplied to the polishing pad 110, each of the slurry and the temperature controlling fluid may be supplied to the polishing pad 110 at a different temperature from the surface temperature of the polishing pad 110. Therefore, due to the difference between the surface temperature of the polishing pad 110 and the temperature of the slurry or the temperature controlling fluid, water vapor is generated in an internal space of a chamber in which the chemical mechanical polishing device 10 is arranged. Such water vapor may stay in the internal space of the chamber or may be introduced into the chemical mechanical polishing device 10 along with the rotation of the polishing pad 110. The water vapor introduced into the chemical mechanical polishing device 10 may be liquefied in the chemical mechanical polishing device 10 and thus corrode the chemical mechanical polishing device 10. In addition, the water vapor staying in the internal space of the chamber may be liquefied at the surface of the chemical mechanical polishing device 10 and thus contaminate the polishing pad 110 or generate defects on the wafer W.

In addition, the surface temperature of the polishing pad 110 is maintained high by the temperature adjuster 180, and when the polishing pad 110 has a high temperature, the slurry supplied onto the polishing pad 110 has high adsorptive power due to thermal energy. The slurry having high thermal energy is continuously brought into physical contact with the temperature adjuster 180 or the carrier head assembly 140 and readily clings to the temperature adjuster 180 or the carrier head assembly 140 due to the high adsorptive power of the slurry. When the slurry remains on the temperature adjuster 180, there may be some difficulty in transferring the temperature controlling fluid supplied by the temperature adjuster 180 to the polishing pad 110. In addition, when the slurry remains on the carrier head assembly 140, the wafer W may not be properly attached to the carrier head assembly 140.

Referring to FIG. 2, the chemical mechanical polishing device 10a according to an embodiment is illustrated. Although FIG. 1 illustrates that only one carrier head assembly 140 is provided over the polishing pad 110, this is only an example. In the chemical mechanical polishing device 10a shown in FIG. 2, to efficiently use the surface area of the polishing pad 110, it is a matter of course that a plurality of carrier head assemblies (that is, 140a and 140b) may be provided over the polishing pad 110. In addition, although the rotation directions of the carrier head assemblies (that is, 140a and 140b) over the platen 120 driven by platen driving shaft 122 may be the same, this is only an example, and it is a matter of course that the carrier head assemblies 140a and 140b may rotate in different rotation directions.

According to an embodiment, the chemical mechanical polishing device 10a may further include a plurality of cleaning devices 200. The plurality of cleaning devices 200 may include, for example, a first cleaning device 200_P and a second cleaning device 200_Q. The first cleaning device 200_P may be arranged on the lower end of one of the plurality of carrier head assemblies (that is, 140a and 140b), and the second cleaning device 200_Q may be arranged on the lower end of the temperature adjuster 180.

A plurality of motors 154a and 154b may be secured to the lower end of the support structure 156. The plurality of motors (that is, 154a and 154b) may include a first motor 154a and a second motor 154b, and the first motor 154a and the second motor 154b may be arranged on the lower end of the support structure 156 and be laterally apart from each other. Here, in a plan view, the first motor 154a and the second motor 154b may be arranged apart from each other with the same distance from the center of the support structure 156.

In a plan view, the support structure 156 may be configured to rotate in one direction about a first central axis CL1 passing through the center of the support structure 156. Therefore, the first motor 154a and the second motor 154b may rotate about the first central axis CL1, which passes through the center of the support structure 156, and thus be alternately located over the polishing pad 110.

Each of the plurality of carrier head assemblies 140a and 140b may be rotatable. For example, a first driving shaft 152a connected to an upper portion of a first carrier head assembly 140a may rotate by receiving rotational power from the first motor 154a, and a second driving shaft 152b connected to an upper portion of a second carrier head assembly 140b may rotate by receiving rotational power from the second motor 154b.

As described above, the first motor 154a and the second motor 154b may rotate about the first central axis CL1, which passes through the center of the support structure 156, and thus be alternately located over the polishing pad 110. Therefore, the first carrier head assembly 140a connected with the first motor 154a and the second carrier head assembly 140b connected with the second motor 154b may rotate about the first central axis CL1 and thus be alternately aligned over the polishing pad 110. The first carrier head assembly 140a and the second carrier head assembly 140b may be arranged to be point-symmetric to each other about the first central axis CL1. Therefore, when the first carrier head assembly 140a is located over the polishing pad 110, the second carrier head assembly 140b may be located outside the polishing pad 110.

When the second carrier head assembly 140b is located outside the polishing pad 110, the first cleaning device 200_P arranged on the lower end of the second carrier head assembly 140b may clean contaminants remaining on the second carrier head assembly 140b. The first cleaning device 200_P may be secured and arranged outside the polishing pad 110. Therefore, when the second carrier head assembly 140b is located over the polishing pad 110 due to the rotation of the support structure 156 about the first central axis CL1, the first carrier head assembly 140a may be arranged on the first cleaning device 200_P. In this case, the first cleaning device 200_P may clean contaminants (for example, the slurry) remaining on the first carrier head assembly 140a.

According to an embodiment, the first cleaning device 200_P may clean the contaminants remaining on the second carrier head assembly 140b by reciprocating in a first direction D1. In addition, the second cleaning device 200_Q may clean contaminants remaining on the temperature adjuster 180 by reciprocating in a second direction D2. Here, the first direction D1 and the second direction D2 may each correspond to the first horizontal direction (an X direction) shown in FIGS. 3 to 18.

In addition, the temperature adjuster 180 may be configured to rotate about a second central axis CL2 vertically passing through a portion of the temperature adjuster 180. The temperature adjuster 180 may rotate about the second central axis CL2, and here, the temperature adjuster 180 may be selectively located over the polishing pad 110 or outside the polishing pad 110. When the temperature adjuster 180 is located outside the polishing pad 110, the temperature adjuster 180 may be aligned on the second cleaning device 200_Q. When the temperature adjuster 180 is aligned on the second cleaning device 200_Q, the second cleaning device 200_Q may clean the contaminants (for example, the slurry) remaining on the temperature adjuster 180.

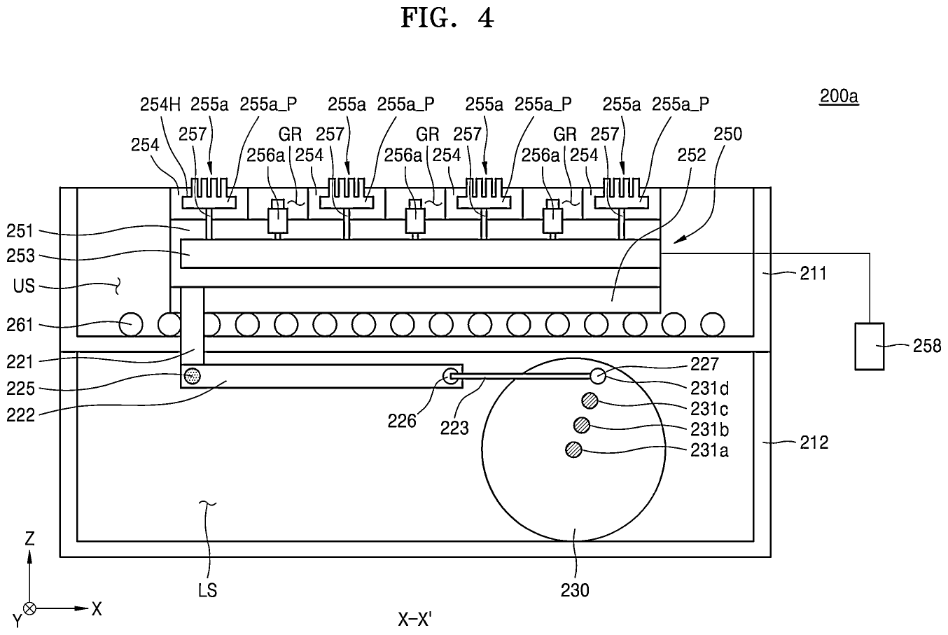

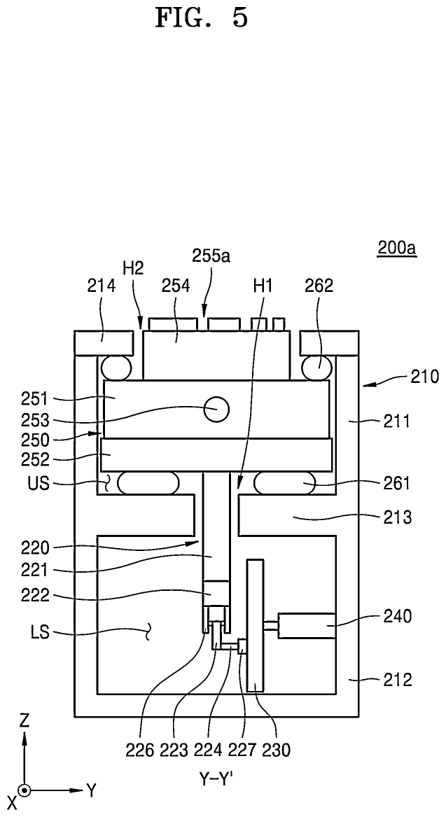

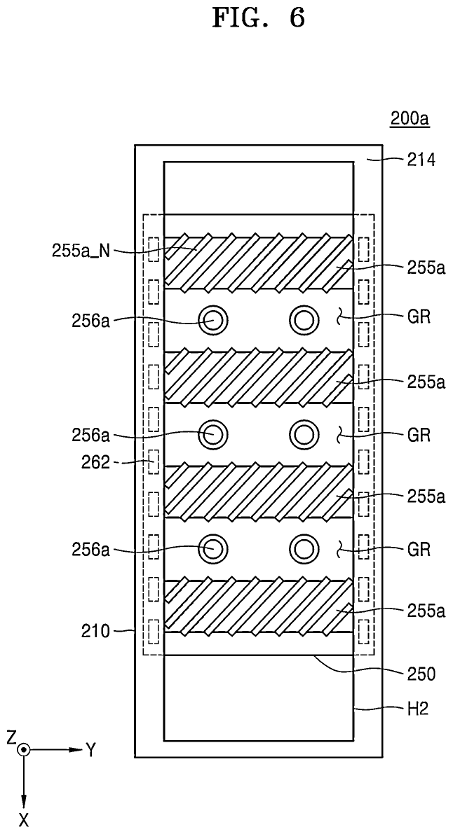

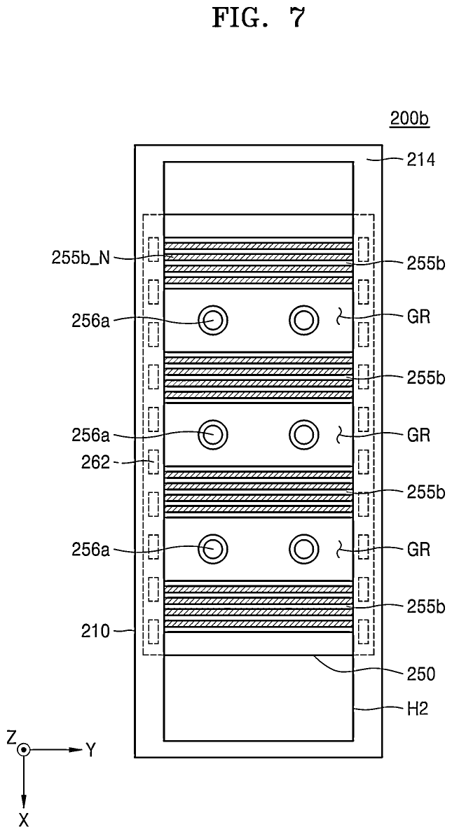

FIG. 3 is a perspective view of a cleaning device 200a. FIG. 4 is a cross-sectional view of the cleaning device 200a, taken along a line X-X′ of FIG. 3, and FIG. 5 is a cross-sectional view of the cleaning device 200a, taken along a line Y-Y′ of FIG. 3. FIG. 6 is a plan view of the cleaning device 200a. Cleaning devices 200b, 200c, 200d, and 200e respectively shown in FIGS. 7 to 10 each correspond to an example of the cleaning device 200a shown in FIGS. 3 to 6.

Referring to FIGS. 3 to 6, the cleaning device 200a may include a frame 210, a driver 220, a driving roller 230, a driving motor 240, a cleaning assembly 250, a first roller 261, and a second roller 262.

The frame 210 may include an upper frame 211, a lower frame 212, a flat plate portion 213, and a cover 214. The frame 210 may provide an upper space US and a lower space LS therein, and here, the upper space US may be defined as a space between the flat plate portion 213 and the upper frame 211 and the lower space LS may be defined as a space between the flat plate portion 213 and the lower frame 212. The flat plate portion 213 is a boundary for separating the upper space US and the lower space LS from each other and may have a first hole H1 extending lengthwise in the first horizontal direction (the X direction).

For reference, in the specification, a direction that is parallel to the upper surface of the flat plate portion 213 and in which the flat plate portion 213 extends lengthwise may be defined as the first horizontal direction (the X direction), and a direction that is parallel to the upper surface of the flat plate portion 213 and perpendicular to the first horizontal direction (the X direction) may be defined as a second horizontal direction (a Y direction). In addition, a direction that is orthogonal to the upper surface of the flat plate portion 213 and perpendicular to the first horizontal direction (the X direction) and the second horizontal direction (the Y direction) may be defined as a vertical direction (a Z direction).

The cover 214 may be located on the upper frame 211 and may have a second hole H2 extending lengthwise in the first horizontal direction (the X direction). The outside and the inside of the cleaning device 200a may be separated from each other by the cover 214 as a boundary. When viewed from outside the cleaning device 200a, the second hole H2 may be a passage through which the inside of the cleaning device 200a may be exposed. The width of the second hole H2 of the cover 214 in the second horizontal direction (the Y direction) may be less than the width of the upper space US in the upper frame 211 in the second horizontal direction (the Y direction). However, the width of the second hole H2 in the second horizontal direction (the Y direction) may be greater than the width of the first hole H1 in the second horizontal direction (the Y direction). When the width of the second hole H2 is sufficiently large, a brush 255a to be described below may more efficiently clean each of the carrier assemblies 140a and 140b (see FIG. 2) and the temperature adjuster 180 (see FIG. 2). In addition, when the width of the second hole H2 is sufficiently large, a nozzle 256a to be described below may stably spray a cleaning fluid toward each of the carrier assemblies 140a and 140b (see FIG. 2) and the temperature adjuster 180 (see FIG. 2).

The cleaning assembly 250 may be arranged over the flat plate portion 213, in the upper space US. Because the width of the cleaning assembly 250 in the second horizontal direction (the Y direction) is greater than the width of the first hole H1 in the second horizontal direction (the Y direction), the cleaning assembly 250 may be settled over the flat plate portion 213 without falling into the first hole H1. The cleaning assembly 250 may be exposed to the outside of the cleaning device 200a by the second hole H2 and may clean each of the carrier assemblies 140a and 140b (see FIG. 2) and the temperature adjuster 180 (see FIG. 2) via a portion of the cleaning assembly 250, which is exposed by the second hole H2. The cleaning assembly 250 may be configured to reciprocate in the first horizontal direction (the X direction) in the upper space US to clean each of the carrier assemblies 140a and 140b (see FIG. 2) and the temperature adjuster 180 (see FIG. 2). This is described below in detail.

According to an embodiment, the driving roller 230 may be arranged in the lower space LS and configured to rotate in place. The driving roller 230 may have a circular plate shape having a base (an upper surface or a lower surface) and may be arranged in the lower space LS and be apart from an internal lower surface of the lower frame 212. The driving roller 230 may be configured to rotate in place about a central axis thereof, and when the driving roller 230 is in contact with the internal lower surface of the lower frame 212, the driving roller 230 may roll along the lower surface of the lower frame 212. Therefore, for the driving roller 230 to rotate in place without rolling along the lower surface of the lower frame 212, the driving roller 230 may be arranged to be apart from the internal lower surface of the lower frame 212 in the vertical direction (the Z direction).

The driving roller 230 having a circular plate shape may include a plurality of fastening holes (that is, 231a, 231b, 231c, and 231d), which are formed to be apart from the center of the base in a radial direction. Here, a first fastening hole 231a may be formed in the vicinity of the center of the base of the driving roller 230. Relative to the first fastening hole 231a, a second fastening hole 231b, a third fastening hole 231c, and a fourth fastening hole 231d may be respectively arranged gradually farther away from the first fastening hole 231a in the radial direction. The fourth fastening hole 231d may be arranged farthest from the first fastening hole 231a in the radial direction. A distance range in which the cleaning assembly 250 is allowed to reciprocate in the first horizontal direction (the X direction) may vary depending on which fastening hole a third pivot 227 is fastened to, as described below in detail.

The driver 220 may extend from the upper space US to the lower space LS through the first hole H1 of the flat plate portion 213 and may include one end fastened to the base of the driving roller 230 and the other end that is opposite to the one end and connected to the cleaning assembly 250.

Specifically, the driver 220 may include a first arm 221, a second arm 222, a third arm 223, a fourth arm 224, a first pivot 225, a second pivot 226, and a third pivot 227. Here, the first arm 221 may be connected to the cleaning assembly 250. The first arm 221 may extend in the vertical direction (the Z direction) and may maintain an extension angle thereof in a state of extending in the vertical direction (the Z direction) without being tilted while the cleaning device 200a is in operation. The second arm 222 may be connected with the first arm 221 and extend lengthwise in the first horizontal direction (the X direction). Here, the first pivot 225 may be configured to connect an end of the first arm 221 and an end of the second arm 222 to each other. Depending on embodiments, the length of the second arm 222 in the first horizontal direction (the X direction) may be less than the length of the cleaning assembly 250 in the first horizontal direction (the X direction). However, this is only an example, and the present disclosure is not limited thereto.

One end of the third arm 223 may be connected with the end of the second arm 222, and the other end of the third arm 223, which is opposite to the one end of the third arm 223, may be connected with the fourth arm 224. The third arm 223 may be connected with the second arm 222 and extend lengthwise in the first horizontal direction (the X direction). Here, the second pivot 226 may be configured to connect an end of the second arm 222 and an end of the third arm 223 to each other. Although FIG. 4 illustrates that the thickness of the third arm 223 is less than the thickness of the second arm 222 or the first arm 221, the present disclosure is not limited thereto, and the thickness of the third arm 223 may be equal to or greater than the thickness of the second arm 222 or the first arm 221, depending on embodiments. The fourth arm 224 may extend in the second horizontal direction (the Y direction), unlike the second arm 222 or the third arm 223.

As shown in FIG. 5, the fourth arm 224 may extend in the second horizontal direction (the Y direction) from an end of the third arm 223 toward the driving roller 230. One end of the fourth arm 224 may be connected with the third arm 223, and the other end of the fourth arm 224, which is opposite to the one end of the fourth arm 224, may be connected with the driving roller 230. The third pivot 227 may be configured to secure the other end of the fourth arm 224 to the driving roller 230. Here, the fourth arm 224 may be fastened to one of the plurality of fastening holes (that is, 231a, 231b, 231c, and 231d), and the third pivot 227 may secure the fourth arm 224 to the one of the plurality of fastening holes (that is, 231a, 231b, 231c, and 231d) such that the fourth arm 224 is fastened thereto and then not separated therefrom. The third pivot 227 may include, for example, a pivot screw.

According to an embodiment, the third arm 223 may be configured to rotate by using the second pivot 226 as a rotation shaft extending in the second horizontal direction (the Y direction) in correspondence with the driving roller 230 that rotates.

The driving motor 240 may be arranged in the lower space LS of the frame 210. The driving motor 240 may be secured to an inner wall of the lower frame 212. The driving motor 240 may be connected to a central shaft of the driving roller 230 and configured to rotate the driving roller 230. The driving roller 230 may rotate by taking the second horizontal direction (the Y direction) as a rotation axis.

The cleaning assembly 250 may include a first body 251, a second body 252, a fluid supplying tube 253, a brush fastener 254, a plurality of brushes 255a, a plurality of nozzles 256a, a brush cleaning nozzle 257, and a cleaning liquid source 258.

The first body 251 may be arranged on the second body 252, and the first arm 221 of the driver 220 may be fastened to the second body 252. Although FIGS. 4 and 5 illustrate that each of the first body 251 and the second body 252 has a shape of a rectangular parallelepiped, this is only for convenience of illustration, and the present disclosure is not limited thereto. As shown in FIG. 5, the second body 252 may have an upper surface that is greater in size than the first body 251 in the second horizontal direction (the Y direction). This is only an example illustrating a structure allowing the first body 251 to be more stably settled on the second body 252 because the first body 251 is settled on the second body 252, and the present disclosure is not limited thereto.

The fluid supplying tube 253, which extends lengthwise in the first horizontal direction (the X direction), may be arranged in the first body 251. The fluid supplying tube 253 may be connected with the cleaning liquid source 258 located outside the cleaning device 200a and may be configured to supply a cleaning fluid, which is supplied from the cleaning liquid source 258, to the plurality of nozzles 256a or the brush cleaning nozzle 257. The cleaning liquid source 258 may include, but is not limited to, a mixed solution in which ammonia, hydrogen peroxide solution, and DI water are mixed.

A plurality of brush fasteners 254 may be arranged on the first body 251 and be apart from each other in the first horizontal direction (the X direction). Although FIG. 4 illustrates that sidewalls of the brush fasteners 254 arranged on edges of the first body 251 are respectively coplanar with sidewalls of the first body 251, the present disclosure is not limited thereto. The plurality of brushes 255a may be fastened respectively to the plurality of brush fasteners 254 and thus be arranged apart from each other in the first horizontal direction (the X direction).

A brush fastening groove 254H, to which a brush 255a may be fastened, may be formed in the brush fastener 254. The brush 255a is not always secured to the brush fastener 254 and may be selectively attached to or detached from the brush fastener 254.

The brush 255a may include a plate 255a_P and a nodule 255a_N protruding in the vertical direction (the Z direction) from the plate 255a_P, the plate 255a_P having an upper surface that is parallel to the first horizontal direction (the X direction) and/or the second horizontal direction (the Y direction) and having a shape in which the width or length of the upper surface of the plate 255a_P is greater than the height of the plate 255a_P. The plate 255a_P may be arranged inside the brush fastener 254 and thus not be exposed to the outside of the cleaning device 200a. However, the nodule 255a_N may be exposed to the outside of the cleaning device 200a by the second hole H2 that is formed in the cover 214. Here, a vertical level of the uppermost end of the nodule 255a_N may be higher than a vertical level of the uppermost end of the cover 214.

As shown in FIG. 6, the nodule 255a_N may be obliquely tilted with respect to the first horizontal direction (the X direction) or the second horizontal direction (the Y direction), in a plan view. Because the cleaning assembly 250 may reciprocate in the first horizontal direction (the X direction), it may be effective for the nodule 255a_N to be tilted by as much as at least a certain angle or more with respect to the first horizontal direction (the X direction) rather than to extend in the first horizontal direction (the X direction). When the cleaning device 200a operates, the nodule 255a_N may be brought into contact with the carrier head assembly 140a or 140b or the temperature adjuster 180 and thus remove the slurry remaining on the carrier head assembly 140a or 140b or the temperature adjuster 180. When the nodule 255a_N is tilted with respect to the first horizontal direction (the X direction), the entire regions of the lower surface of the carrier head assembly 140a or 140b or the entire regions of the lower surface of the temperature adjuster 180 may be brought into contact with the nodule 255a_N.

A groove GR may be formed between each of the plurality of brush fasteners 254 arranged apart from each other in the first horizontal direction (the X direction). The groove GR may be defined to be a space surrounded by the upper surface of the first body 251 and the sidewall of each brush fastener 254. A nozzle 256a may be arranged in each of a plurality of grooves GR. The nozzle 256a may be connected with the fluid supplying tube 253 and may receive the cleaning fluid from the fluid supplying tube 253. The nozzle 256a may be configured to spray the cleaning fluid toward the carrier head assembly 140a or 140b or the temperature adjuster 180, which is arranged on the cleaning device 200a, when the cleaning device 200a operates. That is, when the brush 255a removes contaminants remaining on the carrier head assembly 140a or 140b or the temperature adjuster 180 while the cleaning assembly 250 reciprocates in the first horizontal direction (the X direction), the nozzle 256a may also remove the contaminants by spraying the cleaning fluid with high pressure to the carrier head assembly 140a or 140b or the temperature adjuster 180. The cleaning by the brush 255a and the cleaning by the nozzle 256a may be simultaneously implemented, thereby allowing more efficient cleaning to be performed.

According to an embodiment, the brush cleaning nozzle 257 may be arranged under the brush fastener 254. The brush cleaning nozzle 257 may be connected with the fluid supplying tube 253 and may receive the cleaning fluid from the fluid supplying tube 253. The brush cleaning nozzle 257 may be exposed in the brush fastening groove 254H, and when the brush 255a is separated from the brush fastener 254, the brush cleaning nozzle 257 may clean the brush fastening groove 254H by spraying the cleaning fluid thereto. Alternatively, the brush cleaning nozzle 257 may be configured to continuously spray the cleaning fluid and thus remove contaminants remaining on the brush 255a, when the cleaning device 200a operates.

The first roller 261 may be arranged between the flat plate portion 213 and a lower portion of the cleaning assembly 250. Here, the first roller 261 may be configured to roll in place while having a rotation axis in the second horizontal direction (the Y direction). When the cleaning assembly 250 reciprocates in the first horizontal direction (the X direction), the cleaning assembly 250 may slide by the first roller 261 configured to be rotatable.

The second roller 262 may be arranged between the cover 214 and an upper portion of the cleaning assembly 250. Here, the second roller 262 may be configured to roll in place while having a rotation axis in the second horizontal direction (the Y direction). When the cleaning assembly 250 reciprocates in the first horizontal direction (the X direction), the cleaning assembly 250 may slide by the second roller 262 configured to be rotatable.

That is, the first roller 261 and the second roller 262 may be respectively arranged under the lower end of the cleaning assembly 250 and on the upper end of the cleaning assembly 250 and may guide the cleaning assembly 250 to reciprocate in the first horizontal direction (the X direction) without the movement of the cleaning assembly 250 in the vertical direction (the Z direction) in the upper space US.

FIGS. 7, 8, and 9 are respectively plan views of cleaning devices 200b, 200c, and 200d of chemical mechanical polishing devices according to some embodiments. Referring to FIGS. 7 to 9, as compared with the plan view of the cleaning device 200a shown in FIG. 6, each of the cleaning devices 200b, 200c, and 200d is almost the same as or similar to the cleaning device 200a except that there is a difference in brush shape therebetween. Therefore, the descriptions of the components, which have already been given with reference to FIG. 6, are omitted or briefly made.

Referring to FIG. 7, a plurality of brushes 255b may be arranged on the first body 251 and be apart from each other in the first horizontal direction (the X direction). A brush 255b may include a plate 255a_P (see FIG. 4) and a nodule 255b_N protruding in the vertical direction (the Z direction) from the plate 255a_P (see FIG. 4), the plate 255a_P having an upper surface that is parallel to the first horizontal direction (the X direction) and/or the second horizontal direction (the Y direction) and having a shape in which the width or length of the upper surface of the plate 255a_P is greater than the height of the plate 255a_P. However, the nodule 255b_N shown in FIG. 7 may extend in the second horizontal direction (the Y direction), in a plan view, unlike the nodule 255a_N shown in FIG. 6.

As shown in FIG. 7, the nodule 255b_N may extend in the second horizontal direction (the Y direction), in a plan view. Because the cleaning assembly 250 may reciprocate in the first horizontal direction (the X direction), when the nodule 255b_N extends in the second horizontal direction (the Y direction), the entire regions of the lower surface of the carrier head assembly 140a or 140b or the entire regions of the lower surface of the temperature adjuster 180 may be brought into contact with the nodule 255b_N.

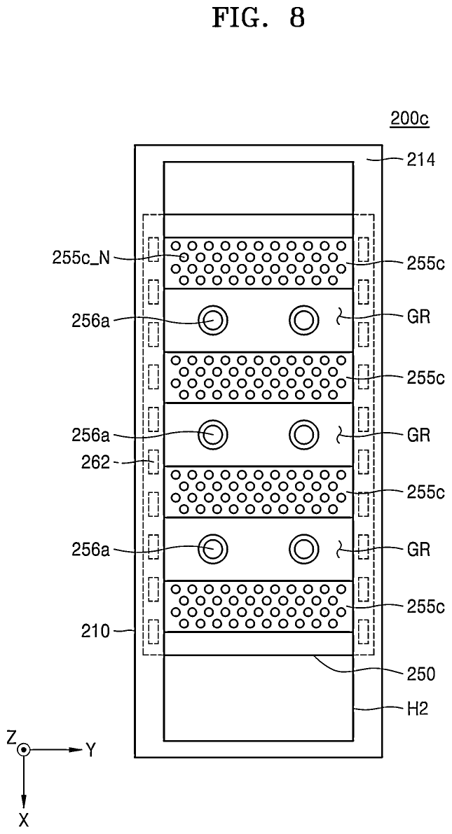

Referring to FIG. 8, a plurality of brushes 255c may be arranged on the first body 251 and be apart from each other in the first horizontal direction (the X direction). The brush 255c may include a plate 255a_P and a nodule 255c_N protruding in the vertical direction (the Z direction) from the plate 255a_P, the plate 255a_P having an upper surface that is parallel to the first horizontal direction (the X direction) and/or the second horizontal direction (the Y direction) and having a shape in which the width or length of the upper surface of the plate 255a_P is greater than the height of the plate 255a_P. However, a plurality of nodules 255c_N shown in FIG. 8 may include island nodules distributed at regular intervals on the plate 255a_P, unlike the nodule 255a_N shown in FIG. 6.

As shown in FIG. 8, the plurality of nodules 255c_N may constitute a plurality of arrays that are apart from each other in the second horizontal direction (the Y direction). In addition, the plurality of arrays may be arranged apart from each other in the first horizontal direction (the X direction). Here, the plurality of arrays apart from each other in the first horizontal direction (the X direction) may be arranged in a staggered manner. Therefore, when the cleaning assembly 250 reciprocates in the first horizontal direction (the X direction), the plurality of nodules 255c_N may be brought into contact with the entire regions of the lower surface of the carrier head assembly 140a or 140b (see FIG. 2) or the entire regions of the lower surface of the temperature adjuster 180.

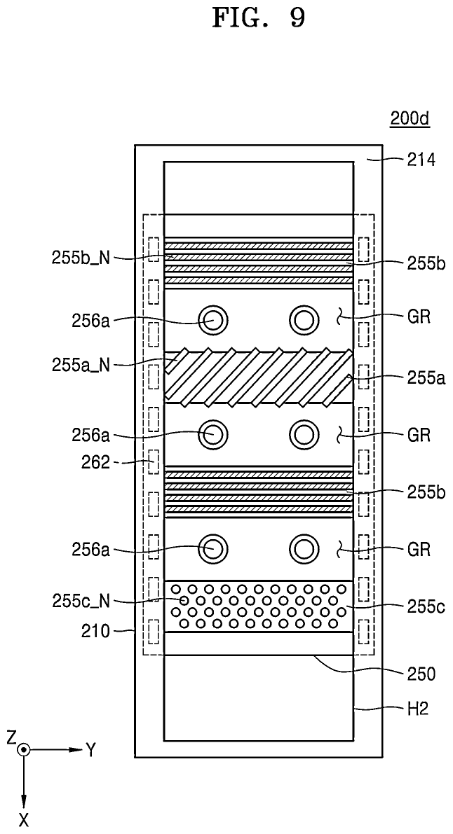

Referring to FIG. 9, a plurality of brushes 255a, 255b, and 255c may be arranged on the first body 251 and be apart from each other in the first horizontal direction (the X direction). The plurality of brushes 255a, 255b, and 255c shown in FIG. 9 are the same as the brush 255a shown in FIG. 6, the brush 255b shown in FIG. 7, and the brush 255c shown in FIG. 8, respectively.

Although FIG. 9 illustrates that there are two brushes 255b shown in FIG. 7 and one of each of the remaining brushes 255a and 255c, the arrangement and respective numbers thereof are not limited to the example set forth above.

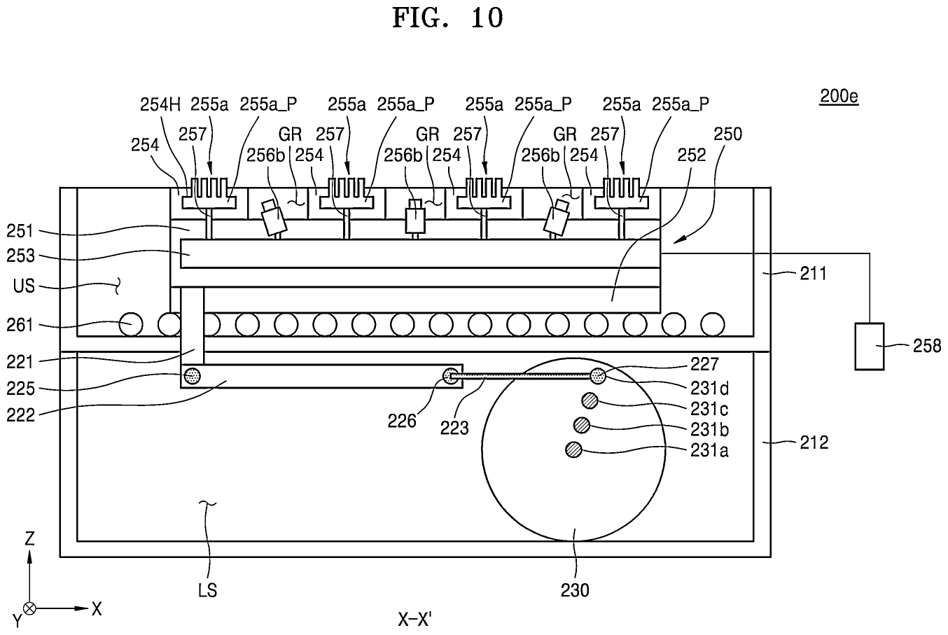

FIG. 10 is a cross-sectional view of a cleaning device 200e of the chemical mechanical polishing device 10a (see FIG. 2) according to an embodiment. Referring to FIG. 10, as compared with the plan view of the cleaning device 200a shown in FIG. 4, the cleaning device 200e is almost the same as or similar to the cleaning device 200a except that the angle of at least some of the nozzles 256b are different from that of the nozzle 256a in the case of the cleaning device 200a. Therefore, the descriptions of the components, which have already been given with reference to FIG. 4, are omitted or briefly made.

Referring to FIG. 10, the chemical mechanical polishing device 10a (see FIG. 2) according to an embodiment may include the cleaning device 200e. Here, the cleaning device 200e may include a plurality of nozzles 256b arranged on the fluid supplying tube 253 and apart from each other in the first horizontal direction (the X direction).

The groove GR may be formed between each of the plurality of brush fasteners 254 arranged apart from each other in the first horizontal direction (the X direction). The groove GR may be defined to be a space surrounded by the upper surface of the first body 251 and the sidewall of each brush fastener 254. The nozzle 256b may be arranged in each of the plurality of grooves GR. The nozzle 256b may be connected with the fluid supplying tube 253 and may receive the cleaning fluid from the fluid supplying tube 253. The nozzle 256b may be configured to spray the cleaning fluid toward the carrier head assembly 140a or 140b (see FIG. 2) or the temperature adjuster 180 (see FIG. 2), which is arranged on the cleaning device 200e, when the cleaning device 200e operates.

The nozzle 256b shown in FIG. 10 may be configured to be aimed with an oblique (or tilted) angle with respect to the vertical direction (the Z direction) and spray the cleaning fluid while aimed, unlike the nozzle 256a shown in FIG. 4. FIG. 10 illustrates that the nozzle 256b arranged in the middle in terms of the first horizontal direction (the X direction) is aimed in the vertical direction (the Z direction). In addition, the nozzles 256b arranged on both sides of the nozzle 256b arranged in the middle position are each aimed with an oblique (or tilted) angle with respect to the vertical direction (the Z direction) and spray the cleaning fluid. This is only an example, and the tilted angle of each nozzle 256b and the arrangement of the nozzles 256b having tilted angles may be variously modified. At least some nozzles 256b from among the plurality of plurality of nozzles 256b may be tilted at an oblique angle with respect to the vertical direction (the Z direction), and thus, the cleaning fluid may be sprayed throughout a larger area.

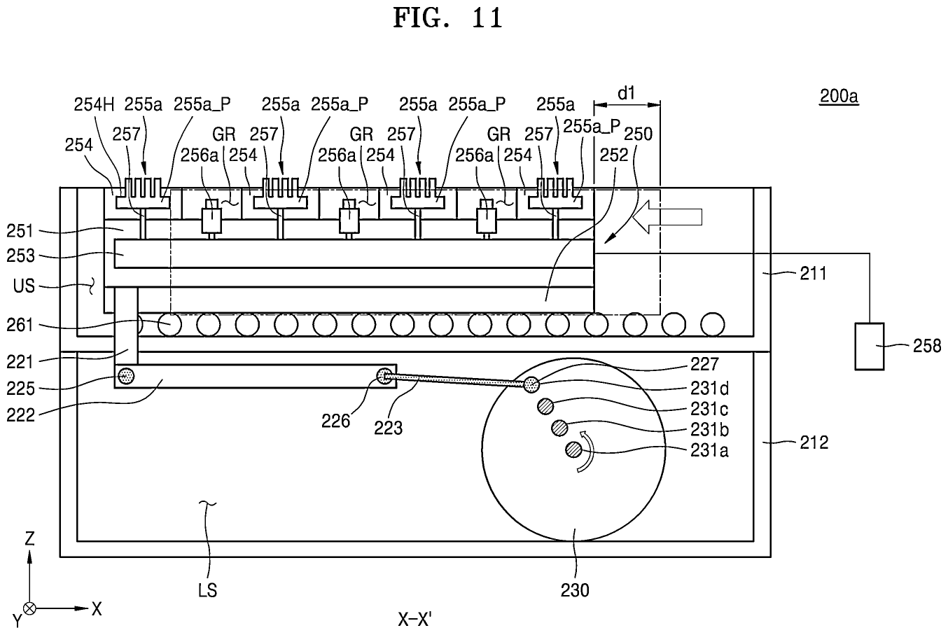

FIGS. 11 to 14 are cross-sectional views and plan views illustrating an operation process of the cleaning device 200a of the chemical mechanical polishing device 10a (see FIG. 2) according to an embodiment.

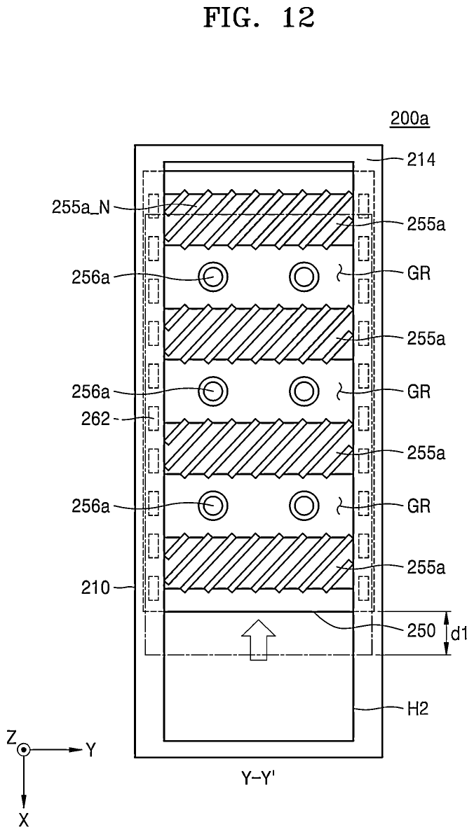

Referring to FIGS. 11 and 12, first, the driving roller 230 may be rotated by operating the driving motor 240. Here, because the driving roller 230 may be arranged apart from the internal lower surface of the lower frame 212 in the vertical direction (the Z direction) without contacting the internal lower surface of the lower frame 212, the driving roller 230 does not roll along the bottom of the lower frame 212 even when the driving roller 230 rotates.

According to an embodiment, the third pivot 227 may be fastened to the fourth fastening hole 231d, which is at the farthest edge position in the radial direction from among the plurality of fastening holes 231a, 231b, 231c, and 231d formed in the base of the driving roller 230. The third pivot 227 may include, for example, a pivot screw. As the fourth fastening hole 231d, to which the third pivot 227 is fastened, travels to the left from the viewpoint of the second horizontal direction (the Y direction) due to the rotation of the driving roller 230, the first arm 221, the second arm 222, and the third arm 223, which are connected with the third pivot 227, may also travel toward the left. Here, the cleaning assembly 250 moving integrally with the first arm 221 slides toward the left by the first roller 261 and the second roller 262. Here, the maximum distance, by which the cleaning assembly 250 may move in the first horizontal direction (the X direction) from the center of the upper space US based on the first horizontal direction (the X direction), may be defined to be a first distance d1.

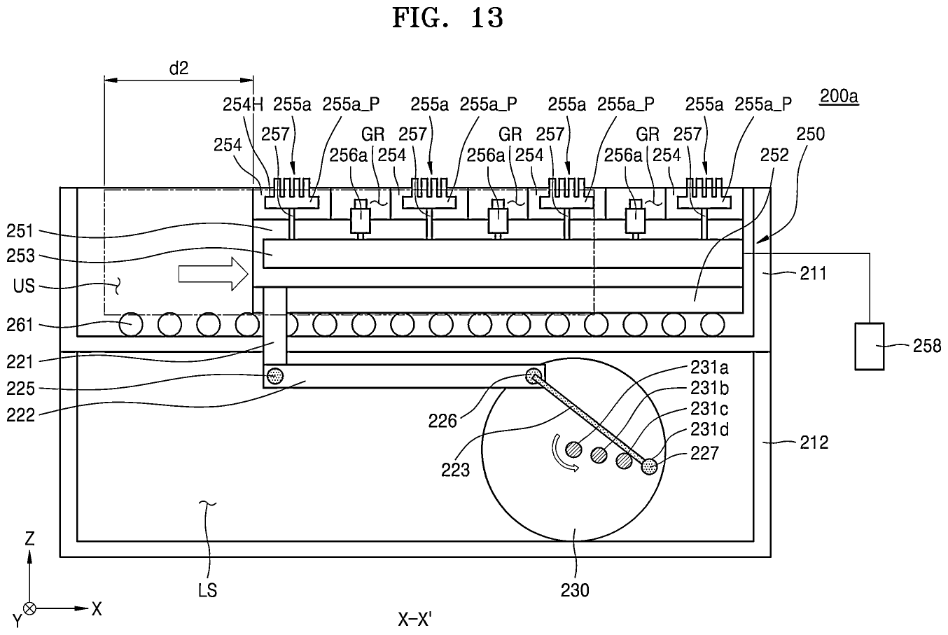

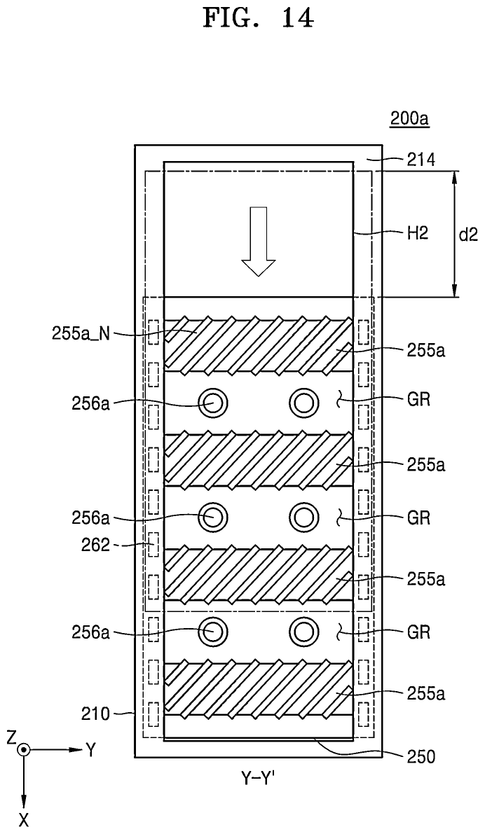

Referring to FIGS. 13 and 14, the driving motor 240 may continue to operate, and thus, the driving roller 230 may continue to rotate. Here, the fourth fastening hole 231d, to which the third pivot 227 is fastened, travels to the right from the viewpoint of the second horizontal direction (the Y direction) due to the rotation of the driving roller 230. As the fourth fastening hole 231d, to which the third pivot 227 is fastened, travels to the right from the viewpoint of the second horizontal direction (the Y direction) due to the rotation of the driving roller 230, the first arm 221, the second arm 222, and the third arm 223, which are connected with the third pivot 227, may also travel toward the right. Here, the cleaning assembly 250 moving integrally with the first arm 221 slides toward the right by the first roller 261 and the second roller 262. Here, a distance from the leftmost position of the cleaning assembly 250 according to the first horizontal direction (the X direction) in the upper space US to the rightmost position of the cleaning assembly 250 according to the first horizontal direction (the X direction) in the upper space US may be defined to be a second distance d2.

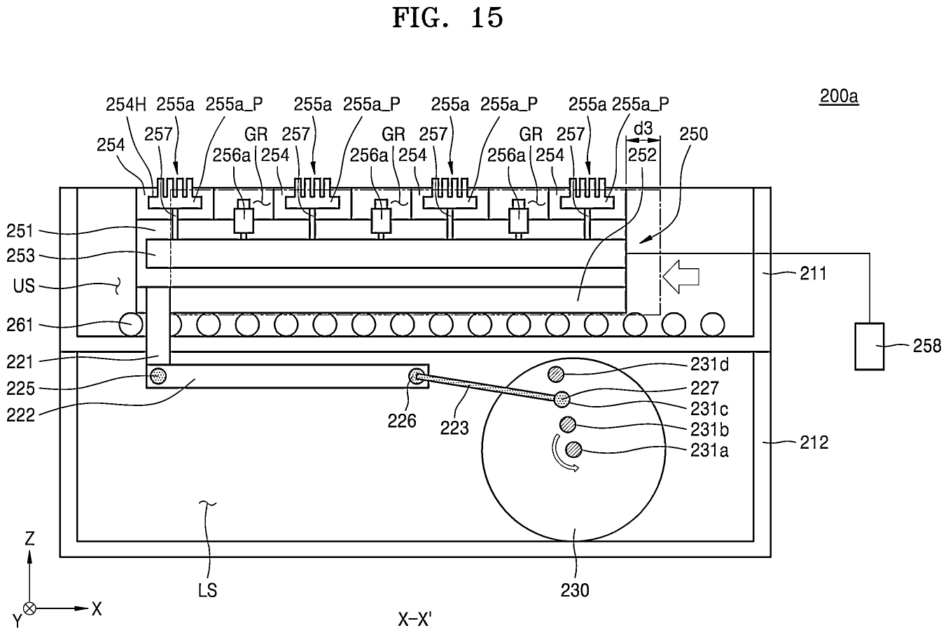

FIGS. 15 to 18 are cross-sectional views and plan views illustrating another operation process of the cleaning device 200a of the chemical mechanical polishing device 10a (see FIG. 2) according to an embodiment.

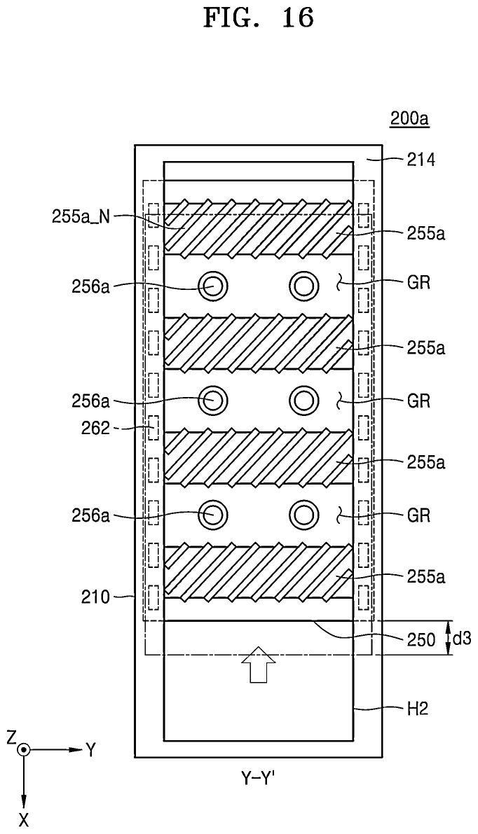

Referring to FIGS. 15 and 16, as compared with the cleaning device 200a of the chemical mechanical polishing device 10a (see FIG. 2) shown in FIGS. 11 to 14, the cleaning device 200a of the chemical mechanical polishing device 10a (see FIG. 2) shown in FIGS. 15 to 18 has a difference in that the third pivot 227 is not fastened to the fourth fastening hole 231d located at the farthest edge position in the radial direction from among the plurality of fastening holes 231a, 231b, 231c, and 231d formed in the base of the driving roller 230.

Specifically, the third pivot 227 is fastened to the third fastening hole 231c, which is third-farthest in the radial direction from the center of the base of the driving roller 230 from among the plurality of fastening holes 231a, 231b, 231c, and 231d.

As the third fastening hole 231c, to which the third pivot 227 is fastened, travels to the left from the viewpoint of the second horizontal direction (the Y direction) due to the rotation of the driving roller 230, the first arm 221, the second arm 222, and the third arm 223, which are connected with the third pivot 227, may also travel toward the left. Here, the cleaning assembly 250 moving integrally with the first arm 221 slides toward the left by the first roller 261 and the second roller 262. Here, the maximum distance, by which the cleaning assembly 250 may move in the first horizontal direction (the X direction) from the center of the upper space US based on the first horizontal direction (the X direction), may be defined to be a third distance d3.

However, because the third pivot 227 is fastened to the third fastening hole 231c, the rotation radius of the third pivot 227 may be less than that in the case of the cleaning device 200a shown in FIGS. 11 to 14. Therefore, the third distance d3, by which the cleaning assembly 250 has slid to the left in the first horizontal direction (the X direction), may be less than the first distance d1.

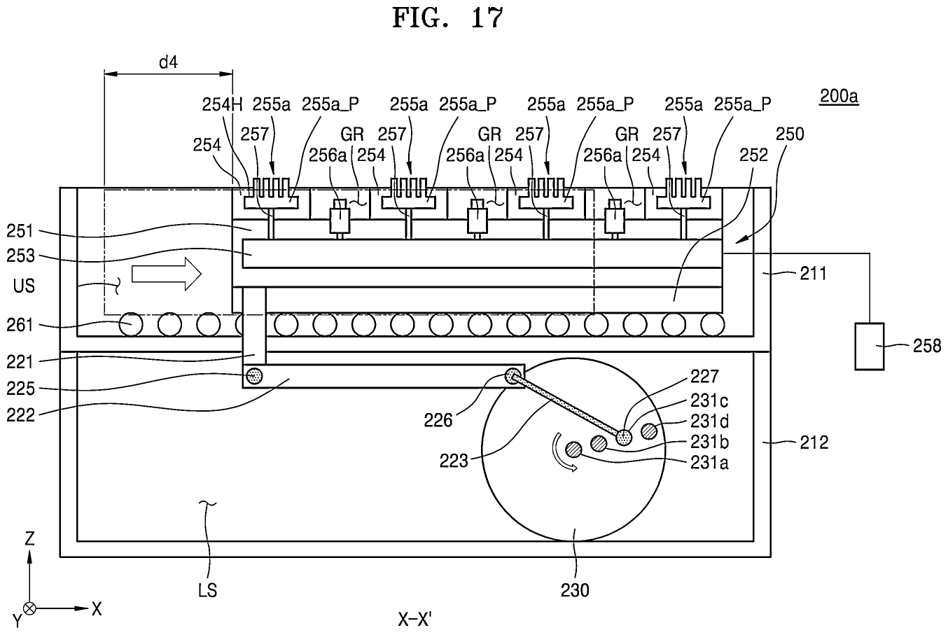

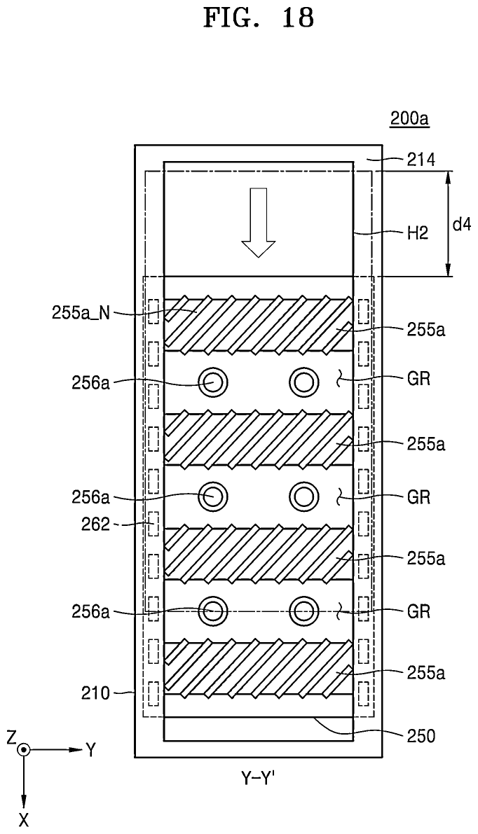

Referring to FIGS. 17 and 18, the driving motor 240 may continue to operate, and thus, the driving roller 230 may continue to rotate. Here, the third fastening hole 231c, to which the third pivot 227 is fastened, travels to the right from the viewpoint of the second horizontal direction (the Y direction) due to the rotation of the driving roller 230. As the third fastening hole 231c, to which the third pivot 227 is fastened, travels to the right from the viewpoint of the second horizontal direction (the Y direction) due to the rotation of the driving roller 230, the first arm 221, the second arm 222, and the third arm 223, which are connected with the third pivot 227, may also travel toward the right. Here, the cleaning assembly 250 moving integrally with the first arm 221 slides toward the right by the first roller 261 and the second roller 262. Here, a distance from the leftmost position of the cleaning assembly 250 according to the first horizontal direction (the X direction) in the upper space US to the rightmost position of the cleaning assembly 250 according to the first horizontal direction (the X direction) in the upper space US may be defined to be a fourth distance d4.

However, because the rotation radius of the third pivot 227 is less than that in the case of the cleaning device 200a shown in FIGS. 11 to 14, the fourth distance d4, by which the cleaning assembly 250 has slid to the right according to the first horizontal direction (the X direction), may be less than the second distance d2.

Therefore, depending on which one of the plurality of fastening holes 231a, 231b, 231c, and 231d arranged in the radial direction in the driving roller 230 the third pivot 227 is fastened to, the movement radius of the cleaning assembly 250 may be adjusted.

While the present disclosure has been particularly shown and described with reference to embodiments thereof, it will be understood that various changes in form and details may be made therein without departing from the spirit and scope of the following claims.

What is claimed is:

1. A chemical mechanical polishing device comprising:
a frame providing a lower space and an upper space in the frame, the frame comprising a flat plate portion that separates the lower space and the upper space from each other and has a first hole;
a driving roller arranged in the lower space and configured to rotate in place;
a cleaning assembly arranged in the upper space and configured to reciprocate in a first horizontal direction that is parallel to an upper surface of the flat plate portion; and
a driver extending from the upper space to the lower space through the first hole of the flat plate portion, the driver having one end fastened to a base of the driving roller and another end that is opposite to the one end and connected to the cleaning assembly,
wherein the cleaning assembly comprises a plurality of brushes, which are arranged apart from each other in the first horizontal direction, and a plurality of nozzles arranged respectively between the plurality of brushes.

2. The chemical mechanical polishing device of claim 1, wherein the driver comprises:
a first arm connected with the cleaning assembly and extending in a vertical direction through the first hole, the vertical direction being perpendicular to the upper surface of the flat plate portion;
a second arm connected with the first arm and extending in the first horizontal direction;
a third arm having one end connected with the second arm and another end that is opposite to the one end and connected with the driving roller; and
a pivot securing the third arm to the second arm, and
wherein the third arm is configured to rotate by using the pivot as a rotation shaft in correspondence with the driving roller that rotates.

3. The chemical mechanical polishing device of claim 2, wherein the driving roller comprises a plurality of fastening holes arranged apart from a center of the base of the driving roller in a radial direction,
wherein the driver further comprises a fourth arm extending in a second horizontal direction from the third arm, the second horizontal direction being perpendicular to the first horizontal direction, and
wherein the fourth arm is fastened to one of the plurality of fastening holes.

4. The chemical mechanical polishing device of claim 1, wherein the cleaning assembly further comprises a fluid supplying tube extending in the first horizontal direction and configured to supply a fluid to the plurality of nozzles.

5. The chemical mechanical polishing device of claim 1, further comprising a plurality of first rollers arranged between the flat plate portion and a lower portion of the cleaning assembly and each having a rotation axis in a second horizontal direction that is perpendicular to the first horizontal direction,
wherein the cleaning assembly is configured to slide by the plurality of first rollers that rotate.

6. The chemical mechanical polishing device of claim 1, wherein the frame further comprises a cover separating the upper space from the outside of the frame and providing a second hole by which the plurality of brushes and the plurality of nozzles are exposed.

7. The chemical mechanical polishing device of claim 6, wherein a width of the second hole in a second horizontal direction, which is perpendicular to the first horizontal direction, is greater than a width of the first hole in the second horizontal direction.

8. The chemical mechanical polishing device of claim 6, further comprising a plurality of second rollers arranged between the cover and an upper portion of the cleaning assembly and each having a rotation axis in a second horizontal direction that is perpendicular to the first horizontal direction,
wherein the cleaning assembly is configured to slide by the plurality of second rollers that rotate.

9. The chemical mechanical polishing device of claim 1, wherein the driving roller has a shape of a circular plate extending in a second horizontal direction that is perpendicular to the first horizontal direction.

10. The chemical mechanical polishing device of claim 1, further comprising a motor arranged in the lower space and configured to be connected with the driving roller to rotate the driving roller.

11. The chemical mechanical polishing device of claim 1, wherein the plurality of nozzles are each aimed in a vertical direction that is perpendicular to the upper surface of the flat plate portion.

12. A chemical mechanical polishing device comprising:
a polishing pad arranged on a polishing platen and configured to be rotatable;
a carrier head assembly configured to provide a wafer onto the polishing pad;
a temperature adjuster configured to spray, onto the polishing pad, a temperature control fluid for adjusting a temperature of the polishing pad; and
a cleaning device configured to clean a lower surface of the carrier head assembly or a lower surface of the temperature adjuster,
wherein the cleaning device comprises:
a frame providing a lower space and an upper space in the frame, the frame comprising a flat plate portion that separates the lower space and the upper space from each other and has a first hole extending lengthwise in a first horizontal direction;
a driving roller arranged in the lower space and configured to rotate in place;
a cleaning assembly arranged in the upper space and configured to reciprocate in the first horizontal direction; and
a driver extending from the upper space to the lower space through the first hole of the flat plate portion, the driver having one end fastened to a base of the driving roller and another end that is opposite to the one end and connected to the cleaning assembly, and
wherein the cleaning assembly comprises a plurality of brushes and a plurality of nozzles arranged respectively between the plurality of brushes, the plurality of brushes being arranged apart from each other in the first horizontal direction and each comprising a plate having an upper surface that is parallel to an upper surface of the flat plate portion.

13. The chemical mechanical polishing device of claim 12, wherein each of the plurality of brushes comprises a nodule protruding from the upper surface of the plate and extending in an oblique direction with respect to the first horizontal direction.

14. The chemical mechanical polishing device of claim 12, wherein each of the plurality of brushes comprises a nodule protruding from the upper surface of the plate and extending in a second horizontal direction that is perpendicular to the first horizontal direction.

15. The chemical mechanical polishing device of claim 12, wherein each of the plurality of brushes comprises a plurality of island nodules protruding from the upper surface of the plate and distributed at regular intervals on the plate.

16. The chemical mechanical polishing device of claim 12, wherein the cleaning assembly comprises a brush fastener having a brush fastening groove to which one of the plurality of brushes is fastened.

17. The chemical mechanical polishing device of claim 16, wherein the cleaning assembly comprises a brush cleaning nozzle passing through an inside of the brush fastener and exposed by a groove, the brush cleaning nozzle being configured to spray a fluid for cleaning each of the plurality of brushes.

18. The chemical mechanical polishing device of claim 16, wherein the plurality of nozzles are each aimed in an oblique direction with respect to a vertical direction that is perpendicular to the upper surface of the flat plate portion.

19. A chemical mechanical polishing device comprising:
a polishing pad arranged on a polishing platen and configured to be rotatable;
a carrier head assembly configured to provide a wafer onto the polishing pad;
a temperature adjuster configured to spray, onto the polishing pad, a temperature control fluid for adjusting a temperature of the polishing pad;
a first cleaning device configured to clean a lower surface of the carrier head assembly; and
a second cleaning device configured to clean a lower surface of the temperature adjuster,
wherein each of the first cleaning device and the second cleaning device comprises:
a frame providing a lower space and an upper space in the frame, the frame comprising a flat plate portion that separates the lower space and the upper space from each other and has a first hole extending lengthwise in a first horizontal direction;
a driving roller arranged in the lower space and configured to rotate in place;
a cleaning assembly arranged in the upper space and configured to reciprocate in the first horizontal direction; and
a driver comprising a first arm, which is connected with the cleaning assembly and extends through the first hole in a vertical direction that is perpendicular to an upper surface of the flat plate portion, a second arm connected with the first arm and extending in the first horizontal direction, a third arm having one end connected with the second arm and another end that is opposite to the one end and connected with the driving roller, and a pivot securing the third arm to the second arm, and
wherein the cleaning assembly comprises a plurality of brushes and a plurality of nozzles arranged respectively between the plurality of brushes, the plurality of brushes being arranged apart from each other in the first horizontal direction and each comprising a plate having an upper surface that is parallel to the upper surface of the flat plate portion.

20. The chemical mechanical polishing device of claim 19, wherein the plurality of brushes comprise:
a first brush comprising a first nodule, which protrudes from the upper surface of the plate and extends in an oblique direction with respect to the first horizontal direction;
a second brush comprising a second nodule, which protrudes from the upper surface of the plate and extends in a second horizontal direction that is perpendicular to the first horizontal direction; and
a third brush comprising a plurality of island nodules, which protrude from the upper surface of the plate and are distributed at regular intervals on the plate.
